(19) United States
(12) Patent Application Publication
(10) Pub. No.: US 2023/0003308 A1
(43) Pub. Date: Jan. 5, 2023

(54) VALVE ASSEMBLY AND CAGE FOR A VALVE ASSEMBLY

(71) Applicant: FISHER CONTROLS INTERNATIONAL LLC, Marshalltown, IA (US)

(72) Inventors: Shannon E. Jelken, Marshalltown, IA (US); Katherine N. Bartels, Ames, IA (US); Thomas N. Gabriel, Marshalltown, IA (US); Lawrence Martin, Marshalltown, IA (US); Julian A. Mann, Ames, IA (US)

(21) Appl. No.: 17/365,694

(22) Filed: Jul. 1, 2021

(51) Int. Cl. F16K 27/02; F16K 1/04; F16K 1/36

(52) U.S. Cl. CPC F16K 27/02; F16K 1/04; F16K 1/36; F16K 2200/502

(57) ABSTRACT

A valve assembly includes a first body portion, a second body portion secured to the first body portion, and a cage positioned between the first body portion and the second body portion. The cage has a generally cylindrical body, a bore formed longitudinally through the body, a top surface, an opposing bottom surface, an exterior surface, an opposing interior surface, and an integral, unitary annular flange extending from the exterior surface and around a perimeter of the cage. The annular flange includes a first surface configured to engage the first body portion to form a seal between the cage and the first body portion and a second surface configured to engage the second body portion to form a seal between the cage and the second body portion.

### FIELD OF THE DISCLOSURE

The present disclosure relates to valve assemblies, and in particular, a cage for a valve assembly.

### BACKGROUND

Valve assemblies are commonly used in process plants to control the flow of a fluid (e.g., a gas, a liquid, etc.) or any other substance through pipes and/or vessels to which they are connected. A valve assembly is typically composed of one or more inlets and outlets, and includes a control element or member (e.g., a valve gate, a piston, a cage, a valve plug, a control member, etc.) that operates to control fluid flow through apertures that fluidly couple the inlet(s) to the outlet(s). A control member is typically coupled to a valve bonnet that is mechanically coupled (e.g., bolted, clamped, threaded into, etc.) to the valve body. Typically, the control member is configured to engage a sealing structure (e.g., a valve seat) that encompasses a flow path through the valve.

When portions of a valve assembly are coupled together, for example a valve body to a bonnet, a valve body portion to another valve body portion, etc., various seals, such as O-rings or gaskets, are required to prevent fluid flow between the coupled portions. This can require a number of seals, for example, in a typical valve, a seal may be required between a valve body and a cage, between a bonnet and the cage, and between the valve body and the bonnet, which can increase the cost of the valve assembly and make assembly and maintenance more difficult. In addition, the gaskets or O-rings typically used in valve assemblies are soft parts that could wear, break down, and leak when exposed to high temperatures or thermal transients.

### BRIEF SUMMARY OF THE DISCLOSURE

In accordance with one exemplary aspect of the present invention, a valve assembly comprises a first body portion, a second body portion secured to the first body portion, and a cage positioned between the first body portion and the second body portion. The cage has a generally cylindrical body, a bore formed longitudinally through the body, a top surface, an opposing bottom surface, an exterior surface, an opposing interior surface, and an integral, unitary annular flange extending from the exterior surface and around a perimeter of the cage. The annular flange includes a first surface configured to engage the first body portion to form a seal between the cage and the first body portion and a second surface configured to engage the second body portion to form a seal between the cage and the second body portion.

In further accordance with any one or more of the foregoing exemplary aspects of the present invention, the valve assembly may further include, in any combination, any one or more of the following preferred forms.

In one preferred form, the first body portion is a valve body having an inlet, an outlet, and a passage between the inlet and the outlet and the second body portion is a bonnet.

In another preferred form, the first surface and the second surface of the annular flange each extend perpendicular to the exterior surface of the cage.

In another preferred form, the first surface of the annular flange extends at a first angle that is non-perpendicular to the exterior surface of the cage, the second surface of the annular flange extends at a second angle that is non-perpendicular to the exterior surface of the cage, the first body portion has a first beveled edge that engages the first surface of the annular flange, and the second body portion has a second beveled edge that engages the second surface of the annular flange.

In another preferred form, the first surface and the second surface of the annular flange are each arcuate, the first body portion has an arcuate edge that engages the first surface of the annular flange, and the second body portion has an arcuate edge that engages the second surface of the annular flange.

In another preferred form, the cage comprises a beveled edge extending between the bottom surface and the interior surface.

In another preferred form, the cage is manufactured of a first material, the first body portion and the second body portion are manufactured of a second material, and the first material of the cage is softer than the second material of the first body portion and the second body portion.

In another preferred form, the valve assembly comprises a valve plug positioned in and guided by the cage, wherein the cage includes a valve seat extending from the interior surface that engages the valve plug with the valve plug in a closed position.

In accordance with another exemplary aspect of the present invention, a valve assembly comprises a first body portion, a second body portion secured to the first body portion, and a cage positioned between the first body portion and the second body portion. The cage has a generally cylindrical body, a bore formed longitudinally through the body, a top surface, an opposing bottom surface, an exterior surface, an opposing interior surface, and an integral, unitary annular flange extending from the exterior surface and around a perimeter of the cage. The annular flange includes a first surface configured to engage the first body portion to form a seal between the cage and the first body portion.

In further accordance with any one or more of the foregoing exemplary aspects of the present invention, the valve assembly may further include, in any combination, any one or more of the following preferred forms.

In one preferred form, the first body portion is a valve body having an inlet, an outlet, and a passage between the inlet and the outlet and the second body portion is a bonnet.

In another preferred form, the second body portion engages the top surface of the cage to urge the cage toward the first body portion.

In another preferred form, the first surface of the annular flange extends perpendicular to the exterior surface of the cage.

In another preferred form, the first surface of the annular flange extends non-perpendicular to the exterior surface of the cage and the first body portion has a beveled edge that engages the first surface of the annular flange.

In another preferred form, the first surface of the annular flange is arcuate and the first body portion has an arcuate edge that engages the first surface of the annular flange.

In another preferred form, the cage comprises a beveled edge extending between the bottom surface and the interior surface.

In another preferred form, the cage is manufactured of a first material, the first body portion is manufactured of a second material, and the first material of the cage is softer than the second material of the first body portion.

In another preferred form, the valve assembly comprises a valve plug positioned in and guided by the cage, wherein the cage includes a valve seat extending from the interior surface that engages the valve plug with the valve plug in a closed position.

In accordance with another exemplary aspect of the present invention, a cage for a valve assembly comprises a generally cylindrical, integral, unitary, one-piece body having a bore formed longitudinally through the body. The body includes a first means for sealing against a first body portion of the valve assembly that extends from an exterior surface and around a perimeter of the body.

In further accordance with any one or more of the foregoing exemplary aspects of the present invention, the cage for a valve assembly may further include, in any combination, any one or more of the following preferred forms.

In one preferred form, the body comprises a second means for sealing against a second body portion of the valve assembly, the second means extending from the exterior surface and around a perimeter of the body.

In another preferred form, the body comprises a means for engaging a valve plug of the valve assembly with the valve plug in a closed position.

### BRIEF DESCRIPTION OF THE DRAWINGS

FIG. 1 illustrates a side cross-sectional view of an example valve assembly;

FIG. 2 illustrates a perspective view of an example cage of the valve assembly of FIG. 1;

FIG. 3A illustrates an enlarged partial view of a portion of FIG. 1;

FIG. 3B illustrates the enlarged partial view of FIG. 3A with a second example cage having a rectangular flange;

FIG. 3C illustrates the enlarged partial view of FIG. 3A with a third example cage having an arcuate flange;

FIG. 3D illustrates the enlarged partial view of FIG. 3A with a fourth example cage having a flange with a single sealing surface; and

FIG. 4 illustrates an enlarged partial view of another portion of FIG. 1.

### DETAILED DESCRIPTION

The examples disclosed herein relate to a cage and a valve assembly including a cage that includes an integrated, unitary annular flange that creates a seal between the cage and one or more body portions of the valve assembly. Integrating the seal with the cage combines the trim access joint seal and the internal trim seal in one joint, reduces the number of parts in the assembly, and reduces the number of seals need in the valve assembly. In addition, the integrated seal in the cage does not require any gaskets, O-rings, or other soft parts and is robust under high temperatures and thermal transients. Compression of the cage between the body portions causes metal-to-metal contact between the cage and the body portions when the body portions are secured, which creates the seal. The cage can also include a valve seat, which can be integral and unitary with the cage, which would further reduce the number of parts in the assembly.

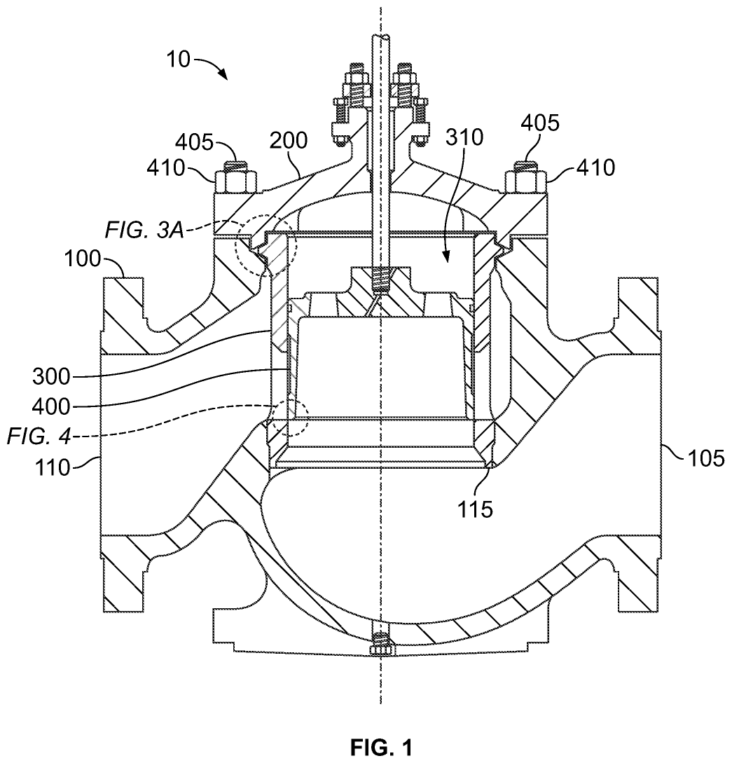

Referring to FIGS. 1-4, an example valve assembly 10 is shown that generally includes a first body portion 100, a second body portion 200 secured to first body portion 100, a cage 300 positioned between first body portion 100 and second body portion 200, and a valve plug 400 positioned in and guided by cage 300. In the example shown, first body portion 100 is a valve body having an inlet 105, an outlet 110, and a passage 115 between inlet 105 and outlet 110 and second body portion 200 is a bonnet. However, first and second body portions 100, 200 can be any portions of the particular valve, such as two body portions, bonnets, blind flanges, etc.

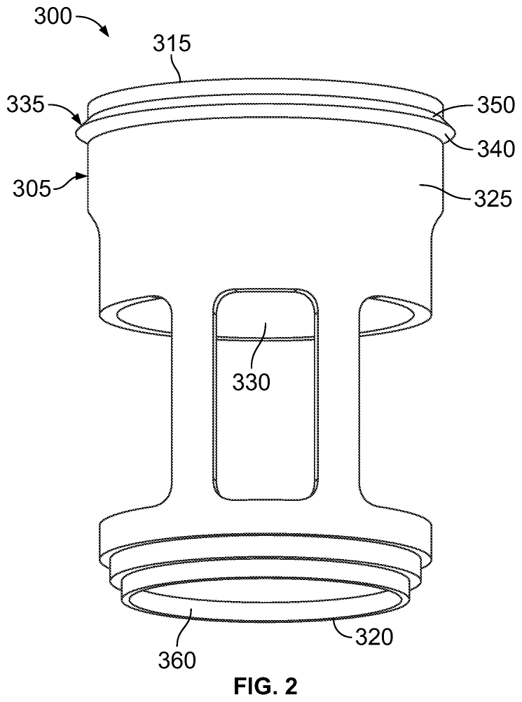

As best seen in FIGS. 1 and 2, cage 300 includes a generally cylindrical body 305, a bore 310 formed longitudinally through body 305, a top surface 315, an opposing bottom surface 320, an exterior surface 325, and an opposing interior surface 330. In the example shown, body 305 is an integral, unitary, one-piece body and has an integral, unitary annular flange 335 that extends from exterior surface 325 and around the perimeter of cage 300. Annular flange 335 has a first surface 340 that is configured to engage first body portion 100 to form a seal between cage 300 and first body portion 100 and a second surface 350 that is configured to engage second body portion 200 and form a seal between cage 300 and second body portion 200. The seals formed between annular flange 335 of cage 300 and first body portion 100 and annular flange 335 and second body portion 200 eliminates the need for additional seals, such as gaskets or O-rings, between these parts. The attachment of first body portion 100 to second body portion 200, with bolts 405 and nuts 410 or any other suitable attachment means, compresses annular flange 335 of cage 300 between first and second body portions 100, 200 and the compression causes metal-to-metal contact between annular flange 335 and first and second body portions 100, 200, creating a seal. To improve the compression of annular flange 335 between first and second body portions 100, 200 and improve the seal, cage 300 can be made of a first material and first and second body portions 100, 200 can be made of a second material that is harder than the first material of cage 300, which could allow annular flange to slightly deform and more closely follow the corresponding surfaces or edges of first and second body portions 100, 200. In addition, during installation or maintenance, a machining operation can be performed on the metal-to-metal contact surfaces to ensure a tight seal. Because the joints between cage 300 and first and second body portions 100, 200 are circular, the orientation of the first body portion 100 to the second body portion 200 does not influence the ability to create the seal.

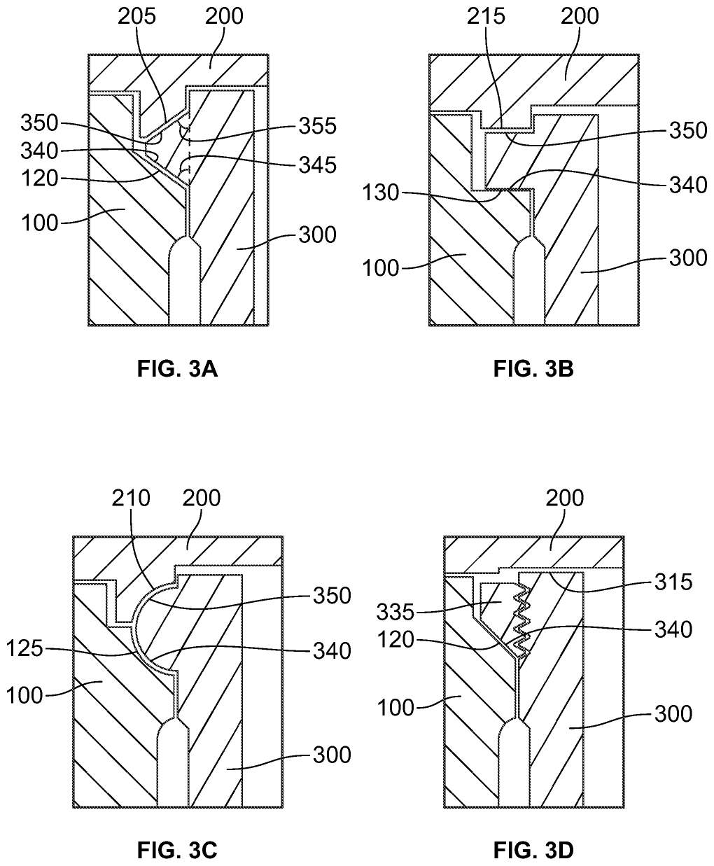

As shown in FIGS. 1-3A, annular flange 335 can be generally triangular with first surface 340 extending at a first angle 345 that is non-perpendicular to exterior surface 325 of cage 300 and second surface 350 extending at a second angle 355 that is non-perpendicular to exterior surface 325. To form the seal between cage 300 and first and second body portions 100, 200, first surface 340 engages a beveled edge 120 of first body portion 100 and second surface 350 engages a beveled edge 205 of second body portion 200. Alternatively, as shown in FIG. 3B, annular flange 335 can be generally rectangular with first and second surfaces 340, 350 extending perpendicular to exterior surface 325 of cage 300 and engaging parallel edges 130, 215 of first and second body portions 100, 200. While first and second surfaces 340, 350 are shown to be generally planar in FIGS. 3A-B, as shown in FIG. 3C, first and second surfaces 340, 350 can also be arcuate and engage an arcuate edges 125, 210 of first and second body portions 100, 200.

Rather than sealing against both first and second body portions 100, 200, as shown in FIG. 3D, annular flange 335 could also have first surface 240 configured to engage first body portion 100 to form a seal between cage 300 and first body portion 100 and second body portion 200 can engage top surface 315 of cage 300 to urge cage 300 toward first body portion 100 and create the seal between cage 300 and first body portion 100. In FIG. 3D, first surface 340 extends non-perpendicular from exterior surface 325 and engages beveled edge 120 of first body portion 100. However, first surface 340 in this example can also extend perpendicular to exterior surface 325 and engage a parallel edge 130 of first body portion 100 (as shown in FIG. 3B) or can be arcuate and engage an arcuate edge 125 of first body portion 100 (as shown in FIG. 3C). In addition, annular flange 335 does not necessarily have to be integral and unitary with cage 300 as shown in FIGS. 3A-3C. Rather, as shown in FIG. 3D, annular flange 335 can be a separate part that is attached to cage 300, for example, by threading annular flange 335 onto cage 300, which can be done with any of the examples shown in FIGS. 3A-3D. Having a separate annular flange 335 that is attached to cage 300 can make maintenance easier if the seal is damaged by removing the cage from the valve, removing the flange from the cage, and replacing only the flange with a new flange.

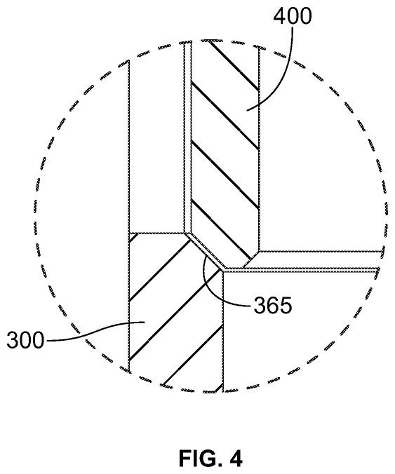

In addition, as shown in FIGS. 1, 2, and 4, cage 300 can also include a valve seat 365, which extends from interior surface 330 of cage 300 and is configured to engage valve plug 400 with valve plug 400 in a closed position, as shown in FIG. 4. In the example shown, valve seat 365 is an integral, unitary part of cage 300. However, valve seat 365 could also be a separate part that is attached to body 305 of cage 300 in any appropriate manner, such as by threading the valve seat to body 305. Cage 300 can also include a beveled edge 360 extending between bottom surface 320 and interior surface 330, or other suitable geometry, which can be used to improve flow into cage 300.

The figures and description provided herein depict and describe a preferred embodiment for purposes of illustration only. One skilled in the art will readily recognize from the foregoing discussion that alternative embodiments of the components illustrated herein may be employed without departing from the principles described herein. Thus, upon reading this disclosure, those of skill in the art will appreciate still additional alternative structural and functional designs. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the methods and components disclosed herein without departing from the spirit and scope defined in the appended claims.

What is claimed is:

1. A valve assembly comprising:
a first body portion;
a second body portion secured to the first body portion; and
a cage positioned between the first body portion and the second body portion, the cage having a generally cylindrical body, a bore formed longitudinally through the body, a top surface, an opposing bottom surface, an exterior surface, an opposing interior surface, and an integral, unitary annular flange extending from the exterior surface and around a perimeter of the cage, wherein the annular flange includes a first surface configured to engage the first body portion to form a seal between the cage and the first body portion and a second surface configured to engage the second body portion to form a seal between the cage and the second body portion.

2. The valve assembly of claim 1, wherein the first body portion is a valve body having an inlet, an outlet, and a passage between the inlet and the outlet and the second body portion is a bonnet.

3. The valve assembly of claim 1, wherein the first surface and the second surface of the annular flange each extend perpendicular to the exterior surface of the cage.

4. The valve assembly of claim 1, wherein the first surface of the annular flange extends at a first angle that is non-perpendicular to the exterior surface of the cage, the second surface of the annular flange extends at a second angle that is non-perpendicular to the exterior surface of the cage, the first body portion has a first beveled edge that engages the first surface of the annular flange, and the second body portion has a second beveled edge that engages the second surface of the annular flange.

5. The valve assembly of claim 1, wherein the first surface and the second surface of the annular flange are each arcuate, the first body portion has an arcuate edge that engages the first surface of the annular flange, and the second body portion has an arcuate edge that engages the second surface of the annular flange.

6. The valve assembly of claim 1, wherein the cage comprises a beveled edge extending between the bottom surface and the interior surface.

7. The valve assembly of claim 1, wherein the cage is manufactured of a first material, the first body portion and the second body portion are manufactured of a second material, and the first material of the cage is softer than the second material of the first body portion and the second body portion.

8. The valve assembly of claim 1, comprising a valve plug positioned in and guided by the cage, wherein the cage includes a valve seat extending from the interior surface that engages the valve plug with the valve plug in a closed position.

9. A valve assembly, comprising:
a first body portion;
a second body portion secured to the first body portion; and
a cage positioned between the first body portion and the second body portion, the cage having a generally cylindrical body, a bore formed longitudinally through the body, a top surface, an opposing bottom surface, an exterior surface, an opposing interior surface, and an integral, unitary annular flange extending from the exterior surface and around a perimeter of the cage, wherein the annular flange includes a first surface configured to engage the first body portion to form a seal between the cage and the first body portion.

10. The valve assembly of claim 9, wherein the first body portion is a valve body having an inlet, an outlet, and a passage between the inlet and the outlet and the second body portion is a bonnet.

11. The valve assembly of claim 9, wherein the second body portion engages the top surface of the cage to urge the cage toward the first body portion.

12. The valve assembly of claim 9, wherein the first surface of the annular flange extends perpendicular to the exterior surface of the cage.

13. The valve assembly of claim 9, wherein the first surface of the annular flange extends non-perpendicular to the exterior surface of the cage and the first body portion has a beveled edge that engages the first surface of the annular flange.

14. The valve assembly of claim 9, wherein the first surface of the annular flange is arcuate and the first body portion has an arcuate edge that engages the first surface of the annular flange.

15. The valve assembly of claim 9, wherein the cage comprises a beveled edge extending between the bottom surface and the interior surface.

16. The valve assembly of claim 9, wherein the cage is manufactured of a first material, the first body portion is manufactured of a second material, and the first material of the cage is softer than the second material of the first body portion.

17. The valve assembly of claim 9, comprising a valve plug positioned in and guided by the cage, wherein the cage includes a valve seat extending from the interior surface that engages the valve plug with the valve plug in a closed position.

18. A cage for a valve assembly, the cage comprising:
a generally cylindrical, integral, unitary, one-piece body having a bore formed longitudinally through the body, the body including:
a first means for sealing against a first body portion of the valve assembly, the first means for sealing extending from an exterior surface and around a perimeter of the body.

19. The cage of claim 18, wherein the body comprises a second means for sealing against a second body portion of the valve assembly, the second means extending from the exterior surface and around a perimeter of the body.

20. The cage of claim 18, wherein the body comprises a means for engaging a valve plug of the valve assembly with the valve plug in a closed position.
